(19) United States
(12) Patent Application Publication
(10) Pub. No.: US 2011/0003274 A1
(43) Pub. Date: Jan. 6, 2011

(54) Educational System for Directionality Enhancement

(76) Inventor: Patty Hannan, Rockwall, TX (US)

Correspondence Address: Eugenia S. Hansen;Hemingway & Hansen, LLP, Comerica Bank Tower Suite # 2500, 1717 Main Street, Dallas, TX, 75201, US

(21) Appl. No.: 12/831,161

(22) Filed: Jul. 6, 2010

Related U.S. Application Data
(63) Continuation of application No. 11/724,047, filed on Mar. 14, 2007, now abandoned.
(60) Provisional application No. 60/782,086, filed on Mar. 14, 2006.

(51) Int. Cl. G09B 19/00

(52) U.S. Cl. 434/258

(57) ABSTRACT

A new system and method for human performance development is disclosed comprising a brain based model for early childhood development, and called the directionality method. It is a neurosensory training system for developing the essential foundation skills for learning and movement. Directionality refers to the profound effect gravity has on human performance. The method is designed to unlock each child's foundation wiring for learning and movement. Using directionality as the key, the method propels future learning and movement ability

### CROSS-REFERENCE TO RELATED APPLICATION

This application is a continuation of copending U.S. application Ser. No. 11/724,047 filed Mar. 14, 2007 which claims the benefit of U.S. Provisional Application Ser. No. 60/782,086 filed Mar. 14, 2006.

### FIELD OF THE INVENTION

This invention relates in general to the field of education in human subjects, more specifically to the enhancement of directionality and motor development in the infant and young child.

### DETAILED DESCRIPTION OF THE INVENTION

Toys, games, books and programs have been available to stimulate motor development of infants and young children. In addition, older children to adults have on occasion needed continued stimulation of motor development due to, for example, particular developmental differences or rehabilitation needs. However, stimulation of motor development has been random and non-systematic.

A new method for optimizing motor development is herein disclosed which constitutes in one embodiment a specific developmental method for progressively stimulating and enhancing motor ability from birth through the early years of life. In a second embodiment, the method is applicable to older children through adults.

In a first embodiment, the method, termed herein “the directionality method,” starts with the' premise that there is a first body axis running along a line from the head to the feet of the human body (herein also color-coded for convenience as the “blue” axis), a second body axis running perpendicular to the first along a line extending from one outstretched arm to the other outstretched arm (herein also color-coded for convenience as the “red axis”), and a third body axis perpendicular to both the first and second axis, extending along a line running from the front of the body though the body to the back side of the body (herein color-coded for convenience as the “yellow (green) axis”). Recognized developmental milestones enhanced by the method of this invention are balance, strength, Visual motor, translation along a body axis and rotation around a body axis.

The method employs creative orientation techniques to maximize a person's neural connections or wiring to recognize body orientation and spatial awareness for each developmental milestone. The creative orientation techniques include changing the body orientation, changing the location of the skill, changing the nature of the surface on which an action is performed, changing the height or depth for the action, changing the direction for the action, and changing the type of motion (speed, flight, rhythm and/or timing) and finally, excelling the purpose of the skill.

Recently, brain function, development and cognitive research have uncovered many new understandings concerning the young brain and its potential ability. While the debate rages on about how and when to start a formalized learning program with infants and toddlers, most experts now agree that babies are born with the ability to learn. Just as it is known that babies are born with motor reflexes (which are tested at birth to assure proper neurophysiologic function) it is now recognized that babies are born with cognitive instincts to assist their ability to learn the information essential for survival about their world. It is also now recognized that the brain grows and learns at an unprecedented speed in the early years. Lack of proper stimulation during this period can lead to cognitive and motor disabilities that are later difficult to overcome or may last a lifetime. Conversely, age appropriate stimulation during key developmental periods can ease and enhance the learning process.

The neurosensory training system focuses on the essential foundation skills for learning and movement. Gravity has a profound effect on the form and function of human performance. Gravity gives the body and the visual field directionality. Directionality can be considered the stage upon which a person's cognitive and motor abilities must function. From how humans learn to how humans move, directionality awareness is critical for propelling early foundation skills and future ability. Persons are born hardwired and innately driven to define their directionality and the directionality of the world. The neurosensory processing systems found in the ‘Feeling Systems’ (vestibular, proprioceptive and somatosensory senses), visual (‘where stream’ wiring) and auditory systems provide tools for directionality awareness.

This method thus opens the visual, auditory and kinesthetic learning pathways. Engaging a child's natural sensory skill abilities using engaging play techniques enhances learning ability and makes learning efficient and fun. Enhancing neurosensory skills enhances ability to learn.

A child is born with the innate drive to make order out of a seemingly chaotic world. The method assists the innate drive to create order by developing the efficiency of the neurosensory skill capability. The quality of our ability to clearly navigate one's visual field and the information within it determines the quality of learning.

Directionality can be enhanced by presentation of specific perceptible visual images in a logical sequence. For example, images depicting portions of a cat photograph or drawing (top half, bottom half, right half, left half) can be presented to a child. Further images depicting a large cat or a small cat, large and small cats on the same image, and a cat in an absurd image (e.g. small cat on the head of a large cat) can be presented. The directionality can be enhanced by moving the image systematically in the visual field of the subject. For example, a photo of a cat lying down may be moved from left to right and from right to left with the accompanying pronouncement “There's a cat lying down.” During this operation, the child naturally follows the image. Another photo of a cat can then be presented and the image moved up and down in the visual field of the subject. For example, an accompanying pronouncement, “There's a cat in a bucket” can be made while a card containing the image described is moved up then down in the subject's visual field. Again, the subject naturally follows the image as it is moved. A subsequent image presents an out-of-the ordinary scenario or absurd image e.g., “There's a little kitty on a big kitty's head.” This image may be moved toward and away from the subject. By the above description, the child has had an image moved in three different directions in relation to its field of vision.

Next, the child is preferably asked to find an image of a cat presented on a card. First the image is presented on a simple background and then a more complex one and the subject asked to point it out. Then the child may be asked to discriminate between a characteristic of two images—i.e. Where is the big cat? On a field presenting a big cat and one or more smaller ones (developing visual acuity and discrimination skills). Finally, an image is presented in an orientation that is not correct e.g. the cat is upside down. The subject is asked to fix it—to put it in the correct orientation in his or her visual field (developing directionality awareness skills). In addition. If the visual field is defined graphically as an essentially rectangular area, one can envision that the image can be presented at any point in the field, or moved in any direction in the field. It is preferred that a sequence of images be moved along the defined green, blue and red axes.

In a most preferred embodiment, specific visual and auditory cues that precisely dissect the directionality of the visual field and the image within it are presented. An image is presented in the expected orientation (e.g. right side up photo of cat) and the opposite orientation (e.g., upside down photo of cat) Knowing “upside down cat” improves the holistic understanding of what “right side up cat” means. Defined basic attributes such as number, color and size reflect some of the brain's hardwiring so learning seems familiar and fun.

Each attribute is presented within a defined spatial location to enhance recognition of classification. The motion of the image with the associated “find it” command by the facilitator specifically stimulates the “where” stream of visual cortical wiring. Motion and tracking is continued beyond the child's personal space. This expands awareness of their potential visual field. The method presents each subject functionally in three ways: an internal action, an external interaction, and a humorous (absurd) image of the subject card to encourage creative thinking. The interactive portion of the card set allows the subject the opportunity to express what they have been learning. An easy then more difficult visual acuity card is presented. These cards encourage seeking strategies and pattern recognition skills. An easy then more difficult discrimination card is then presented. (E.g. large cat with two small cats followed by cat, dog and bunny). Detail and anomaly discrimination enhance recognition skills. The last two cards are the directionality or “fix it cards.” The card is presented so that the image presents in the incorrect orientation—then. the subject is asked to fix it. The child learns to recognize Internal and external directionality Quality directionality skills are essential when learning to read and do math.

A single subject is presented, dissected, turned in different orientations, its position is changed, its attributes are changed and then the subject interacts with it. Constant speed, rhythm and motion and changing visual and auditory input maintains novelty, holding a child's attention. Each change fires different areas of the brain, wiring a dimensional model of what is the subject. The neurosensory skills of focus and tracking anchor the skill of attention. The method uses novelty and changing attributes to enhance recognition. The neurosensory skills of acuity and discrimination anchor the skill of recognition. The interactive components then allow a child to quickly express what they have learned. Applying all the neurosensory skills together with directionality anchors the ability to remember. Carefully matching the brain's existing hardwiring with seeking order, recognizing patterns and symbols, basic attributes and classifying provides an educational method eagerly accepted by children in the early years of life.

The motor development program is designed to foster body confidence in gross and fine motor skills. Using creative orientation techniques, the directionality method nurtures nature by systematically wiring a broad base of movement experience and control. The directionality method is applied to each recognized developmental milestone to enhance body orientation and spatial awareness of each skill. Body confidence makes a child a safe and self confident mover capable of confidentially participating in any physical endeavor or sport.

The body axis allows us to look at the motor skill development from the perspective of gravity. Awareness of the three axis of motion is hardwired into our brain via the vestibular system. The first (or “blue”) axis runs vertically from head to toe. The second (“green” or “yellow”) axis runs from front to back. The third (“red”) axis runs perpendicularly through the body from right to left. The laws of gravity define all motion as occurring along or around one of the three body axis. The blue axis is the foundation axis—the quality of the innate sense of blue determines how well a person's directionality and the directionality of the world are recognized.

We are born hardwired with recognition of the first axis. The goal of the method of the invention is to enhance the directionality recognition the subject already has. One can envision degrees of awareness of the first or “blue” axis on a scale of light blue (less aware) to dark blue (more aware). Innate developmental drive is responsible for recognition of “what is me” and “what is not me.” A baby will begin to move against the forces of gravity and will pass through recognized developmental milestones. This happens in the same order in each child, but at different rates.

For example, rolling over is a rotation around the first or blue axis. The baby learns that front side of the body is different in function and perception from the back side. In the method of the invention, the baby may be provided with different experiences to enhance the awareness. For example, the baby may be provided with a variety of surfaces to roll on such as soft surfaces, firmer surfaces and slight inclines. This will enhance the innate sense of rotating about the first axis.

Sitting upright, (a blue balance) is another developmental milestone. Experiencing sitting in different directions on different types of surfaces and reaching into different spatial planes are ways that directionality method stimulates early balance. These different experiences are provided in a method by a facilitator of the method.

Crawling bilaterally along the first or blue axis is learned (translation along the axis). Perception of a world in motion is different from a world not in motion. The method of the invention provides crawling experiences on various surfaces through levels of space expanding the child's innate knowledge of gravity and the efficiency of our bilateral coordination skills. For example, mats may be provided that provide varied terrains for the child to crawl upon—some at an incline, some level, some smooth, some with build in topography etc. Gravity is critical to our development and the entire first year of life is spent learning about this first or “blue” axis.

The inherent human performance goal is to stand vertical blue and negotiate the world on two feet. It is the quality of the perception of the first or blue axis that helps a person project a clearly defined recognition of the directionality of the world necessary for later developing higher cognitive functions such as reading, math, and problem solving. It is the quality of the perception of the first or blue axis that enhances visual motor skills, the ability to balance well and to perform gross motor skills with smooth coordination and timing. By providing experiences that enhance the awareness of the blue axis through the method of the invention, the performance of the subject is enhanced as well.

All humans are hardwired to translate along an axis. One does not have to be taught to walk (translation along the yellow or green axis), jump (translation along the blue axis) or step sideways (translation along the red axis) However, rotating on an axis must be learned. Rotation involves instruction and problem solving involving higher cortical areas. The primary and secondary reflexes for remaining upright have to be overridden to do rotations (e.g. cartwheels, flips). In the method of the invention, spinning activity is preferably provided to foster discrimination between one's first body axis and the world's directionality.

The directionality method provides enhancement of the innate awareness of one's body axis (“light blue on the color coded scale) to increased awareness (“dark blue on the color coded scale). Awareness of the first or blue axis and the degree of awareness is critical for recognizing directionality and the directionality of the visual field necessary for future human performance ability. A strong perception of body orientation and spatial awareness during movement skills develops the body confidence necessary for successfully participating in any physical endeavor or athletic sport.

In this method, the brains natural hardwiring for recognizing the body axis is matched with exciting and challenging experiences to maximize this awareness.

In a second embodiment, the directionality method presents a new, systematic learning method for understanding and optimizing physical development, motor skill acquisition and motor skill analysis for infants to mature adults, motor delayed to high level athletes and for coaches and sports officials. The method presents a unique way to observe, learn & enhance physical ability by consciously conceptualizing movement in a way that reflects how the brain is wired to detect, define & express movement. The brain is hardwired to detect body movement as well as movement in the visual field. The neurosensory systems found in the vestibular mechanism, proprioceptive system and the ‘where stream’ of visual cortical wiring encode information from the body and/or from the visual field according to 3 characteristics of movement that pertain to directionality awareness. These neurosensory systems are hardwired for detecting location, direction and motion. This processing occurs automatically and below our conscious level and allows us to effectively interface our physics of motion with the world's physics of motion as dictated by our ‘1 G’ gravity environment. Science tells us that because of the constraints of gravity and the principles of physics all human movement and objects of the physical universe, such as balls can be said to have three axis of motion that perform within 3 dimensions of space. Any type of movement can be described as occurring on, along (translation) or around (rotation) an axis, and that all movement takes place within 3 dimensions of space. The brain's neurosensory systems detect motion as it relates to the body axis and the physics of motion. The Directionality Method codes the 3 body axis and the projecting 3 planes of space. A convenient and simple coding method is color coding, but any type of coding can be used.

In the example of using color coding, the method assigns each color a specific characteristic of movement and defines how it reflects the progressive development of human performance ability. A premise of the method is that essentially all skills can be analyzed based upon the 3 movement characteristics. For each level or color of skill ability the method uses certain orientation techniques to enhance awareness of a particular characteristic of skill performance. The method uses ‘color’ to conceptualize human performance development and bring ‘conscious’ awareness to an otherwise unconscious performance processing ability of the brain's neurosensory systems. Performance colors create a conceptual framework to help any person develop, enhance & analyze any skill ability. The method first introduces the ‘color’ of movement by color coding the body axis and the 3 dimensions of space.

BLUE—The blue axis runs from head to toe in our body and from up to down in our visual field. Blue is our main orienting standard that defines our sense of ‘upside right’and the ‘uprightness’ of our world. The human performance goal for Level Blue is expressed as the quality of our ability to maintain positive static (non-moving) balance control of the blue axis in the vertical plane—the ability to stand on two feet. All brains are hardwired to be ‘blue’ as represented by our innate primary vestibular reflexes & secondary postural reflexes. Our ability to balance well on two feet opens the opportunity to perceive movement through the directionality of the 3 dimensions of space as fully realized in the next color level. The goal of the Directionality Method is to enhance balance control for any skill from blue to ‘dark blue’ (superior control). All individuals naturally learn to stand on two feet but not all individuals develop the balance control of the ballerina or gymnast.

YELLOW (or Green)—The Yellow (or Green) axis runs perpendicularly through the body from front to back. Yellow conceptualizes our ability to recognize that we can see and move forward through the depth of the space in front of us. The human performance goal for Level Yellow is expressed as our ability to maintain positive dynamic (upright control of body during movement) control of the body through the 3 dimensions of space. Walking is the ability to ‘translate’ or move forward along the yellow body axis. Jumping is the ability to move up and down along the blue body axis. All brains are hardwired to translate along the body axis as demonstrated by the stepping reflex and jumping reflex. Bilateral coordination (the ability to coordinate the right and left sides of our body) used to propel our body forward opens the opportunity to perceive awareness of our ‘sidedness’ as fully expressed in the next color level. The goal of the Directionality Method is to enhance natural wiring for blue, yellow & red translations to ‘dark colors’ for any skill occurring along the body axis using the Method's progressive orientation techniques. All individuals naturally learn to walk and jump but not all individuals develop the ‘dynamic positive balance’ control (translational movement) ability of the track athlete.

RED—The red axis runs perpendicularly through the body from right to left and helps one conceptualize laterality (right or left ‘sidedness’). Clearly recognizing one's own directionality allows us to appreciate the directionality of ones' visual field and the objects located within it. The human performance goal for Level Red is to fully express laterality (being right or left handed) to effectively manipulate the objects of the physical world. One's visual motor skill ability, such as throwing and kicking are performance expressions of Level Red. Red also conceptualizes one's human performance link to incorporating motion into one's performance skill development. According to the method adding flight & speed (including rhythm & timing) with the directionality awareness of movement at this level excels performance ability. Adding speed and flight propels performance to the level of negative balance control. Negative balance control is the ability to suppress one's postural reflexes and use the additional training for maintaining upright (positive) balance (learned at the previous level) to further excel performance by moving very fast or in a quick coordinated way (superior motion control), propelling the body or ball into parabolic arcs (superior flight control), or rotate around the body axis (superior axis of motion control). The method reflects the same principles of aerodynamics which state that destabilizing an aircraft's axis by making it smaller significantly increases a pilot's control of the craft's maneuverability. The directionality method applies this principle to excel movement skills by allowing the brain greater control of human performance maneuverability. The ability to excel human performance skills by destabilizing the body axis and attaining the level of negative balance control is achieved in Level Red by adding speed, flight and directionality to any skill performance using the method's progressive system of skill development.

The directionality method uses this progression for developing, enhancing & analyzing all motor skill performance. In the method, a unique and innovative way to assure proper skill development, ‘skill mastery’ and to ‘clearly analyze’ skill performance for strengths and weaknesses is enabled. The directionality method can be used to develop infant/toddler motor development programs; programs for developing physical skills & fitness in school age children and adults. The directionality method can also be used for mature adults (e.g., over 50 years old) for maintaining physical dexterity and postural integrity. The directionality method can be used to develop programs for brain injured, autistic spectrum and otherwise developmentally delayed individuals. The directionality method can also be used for developing a ‘physical skill’ diagnostic & prescription for every level including high level athletes of any sport. The directionality method can also be used to develop ‘visual training’ for analyzing & recognizing skill performance for athletes, coaches & officials of all sports.

The Directionality Method—Progressive Skill Training System uses the Performance Science Grids (Tables 1 & 2) (developed, for the directionality method) to recognize the development and analysis of human performance skill ability. The directionality method then applies a system of creative orientation techniques to progressively enhance the development of each skill characteristic propelling the skill to the next level of performance ability. Depending on the skill and the performance requirement (as used for a specific sport—the catching skill is unique in certain performance requirements between baseball and football for instance) the grid information is modified and applied as needed. The grids (Tables 1 & 2) provide the foundation concepts for successfully and progressively applying the system through each movement characteristic.

The Axis of Development Grid (Table 1) represents Human Performance Development according to The Colors of Axis development and the 3 characteristics of movement as defined by the brain's neurosensory systems.

TABLE 1
Performance Science Axis of Development Grid

| Performance | | | |
|---|---|---|---|
| Science Axis | | | |
| of | | | |
| Development | | | |
| Grid | Location | Direction | Motion |
| Blue Development | — Horizontal plane Blue rotation Roll over | 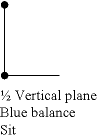 | 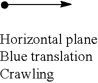 |
| Yellow Development | 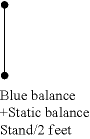 | 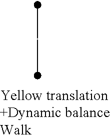 | 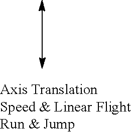 |
| Red Development | 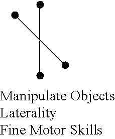 | 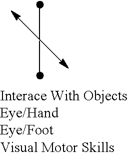 | 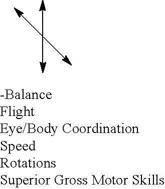 |

Legend for Table 1:
Line with solid pattern represents Blue Color;
Line with dotted pattern represents Yellow Color;
Line with diagonal line represents Red Color

The Axis of Performance Grid (Table 2) represents the progression of skill performance according to the axis colors and the 3 characteristics of movement as defined by the neurosensory systems. This grid is used to define a skill's level of progression. It is also used to enhance training by revisiting previous progressions and applying appropriate orientation techniques to progress performance developmentally to the next level.

TABLE 2
Performance Science Axis of Performance Grid

| Performance | | | |
|---|---|---|---|
| Science Axis of | | | |
| Performance | | | |
| Grid | Location | Direction | Motion |
| Blue | +Static Balance | +Static Balance | +Static Balance |
| Performance | Dark Blue balance | Blue Lower Body | Blue Lower Body |
| Advanced Blue | 1 Foot Balance | Planes of Space | Motion Upper |
| +Balance-Static | Ball of Foot | Upper Body | Body |
| | Balance | Dark Blue Balance | Dark Blue Balances |
| | Handstand/Inverted | ‘Y’ Scale - Side Tilt | Ex: |
| | Balance | Arabesque - Fwd Tilt | Dance Moves In |
| | | | Place |
| | | | Pitching a Ball |
| Yellow | +Dynamic Balance | +Dynamic Balance | −Balance |
| Performance | Linear Flight | Angular Flight | Parabolic Flight |
| Advanced | Blue Coordinated | Translations | Translations |
| Translation | Feet | Coordinated Feet | Coordinated Feet Skills |
| +Dynamic Balance | Ex: | Skills | Ex: |
| | Jumping & | Ex: | Long Jump |
| | Hopping In Place | Dance Skills | Basketball Leap |
| | | Leaps | |
| | | Hops | |
| | | Jumps | |
| | | Galloping | |
| | | Skipping | |
| Red | Fine Motor | Visual Motor | Gross Motor |
| Performance | Speed, Flight & | Eye/Hand | −Balance |
| Advanced Motor | Rhythm | Eye/Foot | Parabolic Arc Flight |
| Skills | Ex: | Eye/Body | Ex: |
| −Static & Dynamic | Piano/Instrument | Speed, Flight & | Professional Throw, |
| Balance | Playing | Direction | Kick, Strike, Catch |
| | Crafts | Catching/Throwing | Gymnastics |
| | | Kicking/Striking | Tumbling |
| | | Axis Rotations | |

The Directionality Method's Orientation Techniques present a progressive system for analyzing and enhancing skill ability. The method takes any skill and locates its root skill on the development grid and analyzes it for its quality of performance based on the method's 3 characteristics of movement: location direction and motion. To enhance the skill the performance grid is used. The skill is first analyzed for balance (location awareness) quality. The method can use the various location techniques to determine the quality of blue awareness in the skill and to create training regimens to enhance any weak areas of balance or location awareness that are present. The method then analyzes a skill for its directionality awareness quality, systematically repeating the process above. The skill is finally analyzed for the characteristic of motion awareness, repeating the progressive analysis and training system described above. The method has determined that the orientation techniques listed below for each movement characteristic are applicable for enhancing awareness and quality of skill progression. The method selects a technique and devises a method of progressive training that would be compatible with the sport, rehabilitation needs or other physical goals of the performer.

Location Techniques

1. Body Position awareness (position of blue body awareness)

a. horizontal plane

b. vertical plane

c. Inverted

2. Surface awareness (gross motor awareness of blue)

a. stable/unstable (such as trampoline) experiences

b. inclined—uphill/downhill

c. width control (such as beams)

3. Levels awareness (visual motor awareness of body orientation to blue space)

a. Height—low, mid, high

b. Depth—near space, mid space, far space

Direction Techniques

1. Body Part awareness (limbs to blue trunk awareness and function)

a. right side/left side

b. upper body/lower body

c. front of body/back of body

2. Translations (linear motion along the body axis)

a. blue (up & down)

b. yellow (forward & backward)

c. red (sideways right & sideways left)

3. Rotations (angular motion around the body axis)

a. blue (rotation spinning right/rotation spinning left)

b. yellow (rotate sideward right/rotate sideward left)

c. red (rotation forward/rotation backward)

Motion Techniques

1. Speed Control

a. continuous volume—low, mid and high (slow to fast)

b. simple rhythm and timing—bilateral and whole body timing (such as used in walking and jumping) using a 1 or 1, 2 repetitive rhythm and timing pattern.

c. complex rhythm and timing—creative and original movement patterns, such as using 8 counts & non-repetitive motion

2. Flight

a. Linear

b. Angular

c. Parabolic

3. Motion experience

a. a. spotting—a person is physically or otherwise supported to experience body shape or position

b. passive—using swings, slides, spotting belts etc.

c. static/dynamic relationships between body & visual focus and tracking (such as a ball) progressions

1. static body/static ball

2. dynamic body/static ball

3. static body/dynamic ball

4. dynamic body/dynamic ball

### Example 1

### Skill Performance Analysis & Enhancement

A human subject, for example a 22 month old child or an older individual, can achieve an enhancement of a skill level over time using the method of the invention. As an example, a progression can taken the primary root skill of jumping to a very advanced awareness of the jumping skill, e.g. from less intense to more intense (or “blue” to “dark blue”) in the coding described supra. A person will have learned location, direction and motion control for the jumping skill in that progression. They will most likely become aware that a certain characteristic is more easily expressed than another. This allows a person to recognize performance strengths and weaknesses and enhance skill performance accordingly. Building strong foundation skills will propel the quality of all future skill progressions so when a child finds a physical interest or sport the wiring will be there for them to fully realize their goals.

For the Jumping Skill enhancement, the following can be used with the human subject:

Analysis: root skill: Jumping
Blue translation
2 feet take off to 2 foot landing
whole body working as single unit
repetitive timing between take-off and landing

Previous skill pattern: walking & running
yellow translation
alternating feet motion
bilateral coordination
smooth timing and continuous speed

Next skill pattern: coordinated feet skills with flight: hopping & leaping
blue & yellow
single foot and opposition foot coordination
repetitive timing and controlled speed

### Example 2

### Progression for Skill Maste Using the Directionality Method'S Orientation Techniques

Location: (Jumping location (balance) awareness enhancement)

1. Body Position awareness: vertical plane

2. Surface awareness:
stable/unstable: practice jumping on a flat surface and a trampoline
inclined surface: jump up & down on a slightly inclined

3. Levels awareness:
Height: jump down from a 4″ height; jump up onto a 4″ height; progressively increase heights to a level consistent with child or athletes needs
Depth: jump up as high as possible (into the depth of space above)

Direction

1. body part awareness
right side/left side: jump with right arm out to the side; repeat to left
upper body/lower body: jump with both arms overhead—upper body awareness; jump tucking only legs—lower body awareness
front of body/back of body: jump & pike legs in front—front of body awareness; jump and kick heels behind—back of body awareness

2. Translations
blue translation—jump up
yellow translation—jump forward
red translation—jump sideways to the right; then sideways to the left

3. Rotations
blue rotation—jump & spin 900 to right; repeat to left; repeat to 1800 & 3600 (yellow & red rotations would become gymnastics rotational skills & not used as the root skill progression for jumping)

Motion

1. Speed control
continuous volume & *simple timing (generally work together): jump repetitively with smooth timing 3X′s in a row at low speed; repeat to medium speed; repeat as fast as you can; repeat whole activity to 5X′s then as many as can be done before rhythm & speed are no longer presenting equal timing.
complex rhythm & timing; jump 2×′s low & slow—1×high & fast; repeat pattern controlling application of force & speed; use other patterns & include direction: For instance 2×′s low, slow & blue—1×high, fast & yellow—repeat changing blue to red & yellow to blue etc. . . .

2. Flight
linear; jump in straight line (showing height or distance) all colors; both directions
angular; jump in an arc (showing height & distance) all colors; all progressions
parabolic; jump from a springboard or trampoline with great effort to propel self into a very large arc (showing great height or distance)

3. Motion experience
spotting: a coach may want to position a child while they are not moving to show them the ideal position for a body that is jumping efficiently; this would be a body position where the legs and buttocks are tightly squeezed and arms stay close to the body
passive: Older children and athletes could experience parabolic jumping using spotting belts on trampolines.
static/dynamic progressions: this does not apply to the jumping skill (it is primarily for ball skills)

In carrying out the method of the invention, a coach or teacher may find upon assessment that an individual has good blue skills, for example, but may not move through directions in a skilled manner. The individual can be taken through the method of the invention and improvements in the yellow (green) and red areas can be realized.

I claim:

1. A method for enhancing the directionality awareness of a human, said method comprising the steps of providing to said human an apparatus for visual display, said apparatus illustrating a series of images which all concern a single subject matter and wherein a portion of said series comprises a first, second and third image, wherein said first image is presented to said child with movement along a first axis, said second image is presented to said child with movement along a second axis, and said third image is presented to said child with movement along a third axis.

2. The method of claim 1, wherein said first, second and third images each further are portrayed in a unique code, and wherein each of said unique codes is subject to conceptionalization by said human.

3. The method of claim 2, wherein said unique code is a color code, and each of said first, second and third images are portrayed in different colors.

4. The method of claim 3, wherein each of said colors is portrayed in an intensity selected from less intense to more intense.

5. The method of claim 3, wherein a motor skill is associated with one of said first, second or third images.

6. The method of claim 3, wherein said first axis is a body axis running from head to toe in a human subject.

7. The method of claim 6, wherein said first axis is coded blue.

8. The method of claim 3, wherein said second axis is a body axis running perpendicularly through said human subject from front to back.

9. The method of claim 8, wherein said second axis is coded a color selected from yellow and green.

10. The method of claim 3, wherein said third axis is a body axis running perpendicularly through said human subject from right to left.

11. The method of claim 10, wherein said third axis is coded red.

12. The method of claim 3, further comprising presenting progressive motor skills to said human subject, each of said motor skills categorized as corresponding to said first, second or third axis.

13. The method of claim 12, wherein said skill is a location skill.

14. The method of claim 13, wherein said location skill is selected from horizontal plane, vertical plane and inverted.

15. The method of claim 12, wherein said skill is a surface awareness skill.

16. The method of claim 15, wherein said surface awareness skill is selected from stable/unstable, inclined, width control, and levels awareness.

17. The method of claim 12, wherein said skill is a direction technique.

18. The method of claim 13, wherein said skill is selected from body part awareness, translations, and rotations.

19. The method of claim 12, wherein said skill is a motion technique.

20. The method of claim 19, wherein said skill is selected from speed control, flight, and motion experience.
